(19) United States
(12) Patent Application Publication
(10) Pub. No.: US 2010/0062722 A1
(43) Pub. Date: Mar. 11, 2010

(54) SYSTEM AND METHOD FOR DETERMINING PATH LOSS IN A USE ENVIRONMENT

(75) Inventors: KURT A. DYKEMA, HOLLAND, MI (US); WARREN GUTHRIE, WEST OLIVE, MI (US); RANDELL L. JEFFERY, STEVENSVILLE, MI (US); RICHARD A. MCCOY, STEVENSVILLE, MI (US); MICHAEL A. MORRELL, HUDSONVILLE, MI (US); ANDREW D. WHIPPLE, SAINT JOSEPH, MI (US)

Correspondence Address: WHIRLPOOL PATENTS COMPANY - MD 0750, 500 RENAISSANCE DRIVE - SUITE 102, ST. JOSEPH, MI, 49085, US

(73) Assignee: WHIRLPOOL CORPORATION, BENTON HARBOR, MI (US)

(21) Appl. No.: 12/552,324

(22) Filed: Sep. 2, 2009

Related U.S. Application Data
(60) Provisional application No. 61/095,406, filed on Sep. 9, 2008.

(51) Int. Cl. H04B 17/00

(52) U.S. Cl. 455/67.11

(57) ABSTRACT

A method includes providing a first data collection unit and a second data collection unit, each of the first test data collection unit and the second data collection unit comprising a wireless transceiver and adapted for wireless communication therebetween, physically moving the first data collection unit to each of a plurality of different locations within the use environment associated with use of the home appliance, establishing a radio frequency link between the first data collection unit and the second data collection unit at each of the plurality of different locations within the use environment, characterizing quality of the radio frequency link at each of the plurality of different locations, the quality of the radio frequency link being at least partially based on the path loss within the use environment, and determining an aggregate characterization of the first data collection unit within the use environment using the quality of the radio frequency link at each of the plurality of different locations. A system for characterizing radio communications quality is also provided.

### CROSS-REFERENCE TO RELATED APPLICATION

This application claims priority to U.S. Provisional Application No. 61/095,406, entitled “SYSTEM AND METHOD FOR DETERMINING PATH LOSS IN A USE ENVIRONMENT”, filed Sep. 9, 2008, herein incorporated by reference in its entirety.

### FIELD OF THE INVENTION

The present invention relates to determining path loss in a use environment. More particularly, but not exclusively, the present invention relates to determining path loss associated with wireless communications to assist in design of home appliances for use in the use environment.

### BACKGROUND OF THE INVENTION

Radio frequency wireless communication technologies may develop signal degradation as a result of both interference and noise. Path loss provides a measure of signal degradation. Path loss can be affected by aspects of the arrangement between two communicating nodes such as distance, physical interference, and noise from electro magnetic sources.

Consider, for example, the home environment. Within the home environment there are many contributors to path loss in a wireless radio frequency (RF) signal, including fading and multi-path. A device within the home environment may not be able to receive particular RF signals due to path loss or if the antenna is positioned at or near a null. Within a home environment, variable like wall construction material, wall position, furniture placement, room size, and other variables may all affect and potentially have an adverse effect on wireless RF signal reception. Such problems become particularly acute in instances where one or more of the devices communicating are stationary and the antenna is internal or does not otherwise move. Thus, a user would be forced to either physically move the complete device or otherwise effect some change in the path loss. This is particularly problematic when the device is large such as a home appliance which is difficult to move and which a consumer would generally want to keep in a predetermined position.

From a manufacturer's perspective, networked home appliance should be able to communicate in an arbitrarily complex RF home environment while allowing customers or users of the home appliances to place the appliance wherever they want. Thus, there is a need to design wireless communication systems for home appliances which allow users to place home appliances which support wireless communications in the home environment at each user's discretion while still ensuring that path loss does not preclude effectively sending or receiving wireless communication signals between the home appliances and other devices in the home. In order to assist in doing so, what is needed is a method and apparatus for characterizing RF path loss in a use environment to assist in making device designs.

### SUMMARY

According to one aspect of the present invention, a method for selecting a wireless communication system for use in a home appliance based on path loss within a use environment is provided. The method includes providing a first data collection unit and a second data collection unit, each of the first test data collection unit and the second data collection unit comprising a wireless transceiver and adapted for wireless communication therebetween. The method further includes physically moving the first data collection unit to each of a plurality of different locations within the use environment associated with use of the home appliance, establishing a radio frequency link between the first data collection unit and the second data collection unit at each of the plurality of different locations within the use environment, and characterizing quality of the radio frequency link at each of the plurality of different locations, the quality of the radio frequency link being at least partially based on the path loss within the use environment. The method further includes determining an aggregate characterization of the first data collection unit within the use environment using the quality of the radio frequency link at each of the plurality of different locations.

According to another aspect of the present invention, a system for characterizing radio communications quality associated with a use environment is provided. The system includes a first data collection unit and a second data collection unit, each of the first data collection unit and the second data collection unit comprising a wireless transceiver and adapted for radio communication therebetween when at least one of the first data collection unit and the second data collection unit is within the use environment. The first data collection unit and the second data collection further adapted for collecting radio link quality data for radio links made between the first data collection unit and the second data collection unit. The system also includes a computing device in operative communication with at least one of the first data collection unit and the second data collection unit, the computing device having a data processing module stored on a computer readable medium, the data processing module adapted for processing the radio link quality data to provide an aggregate characterization of radio communications within the use environment.

### BRIEF DESCRIPTION OF THE DRAWINGS

FIG. 1 is a schematic block diagram of a system for determining path loss in a use environment.

FIG. 2A is a two dimensional diagram of a testing location and data collection sampling paths traversed therein.

FIG. 2B is a three dimensional diagram of a testing location and data collection sampling paths traversed therein.

FIG. 2C is a representation of an operator conducting a data collection sampling.

FIG. 2D is a table view of attributes associated with the collected data samples.

FIG. 3 is a flowchart depicting exemplary steps and decisions related to configuring a data collection.

FIG. 4 is a flowchart depicting exemplary steps and decisions related to initiating a data collection.

FIG. 5 is a flowchart depicting exemplary steps and decisions related to conducting a data collection between master and slave data collection units.

FIG. 6 is a flowchart depicting exemplary steps and decisions related to analyzing collected data samples.

FIG. 7 is a flowchart depicting exemplary steps and decisions related to developing a scaling factor relating signal strength to path loss.

FIG. 8 is a flowchart depicting exemplary steps and decisions related to recommending a radio technology for a particular use environment.

### DETAILED DESCRIPTION OF THE PREFERRED EMBODIMENT

The following disclosure presents systems and methods for determining path loss in a use environment to overcome the problems of existing models. The descriptions set forth herein are not intended to be exhaustive or otherwise limit or restrict any claims based thereon to the precise forms and configurations shown in the drawings and disclosed in the following detailed description.

In order to select a radio frequency technology appropriate for use in appliances, for example, a technology selection methodology must be devised enabling a fair comparison of multiple wireless technologies. Path loss may be used to represent the level of signal attenuation between a transmitter and a receiver. A contributor to path loss in the home, commercial kitchens, Laundromats and other use environments for appliances is fading and multi-path resulting from peaks and valleys of signal strength which are formed when RF waves repeatedly bounce around and reflect off objects and barriers in the use environment. Due to the frequencies in common use today, peaks and nulls can be very close together. A stationary appliance may not be able to receive a radio frequency signal if the antenna is positioned near a null. Moreover, the contributors to fading and multi-path are specific to each use environment. Variables such as wall construction materials, wall positions, furniture material and placement, room size and shape, and angular and spatial dispositions therebetween can affect signal strength and quality. Dynamic conditions, such as electromagnetic interference and people moving around the room may also affect communications to and from the appliance. Therefore, it is particularly beneficial for designers and installers of appliances and of wireless networks using appliances to have systems and methods for better understanding the use environment.

Although the drawings represent contemplated embodiments, the drawings are not necessarily to scale and certain features may be exaggerated to better illustrate and explain the present embodiments. The embodiments set forth herein are not intended to be exhaustive or otherwise limit the invention to the precise forms disclosed in the following detailed description. For example, while the present invention is particularly beneficial when used in connection with networked appliances, the methods and systems described are applicable to more general use in connection with wireless environments and wireless devices.

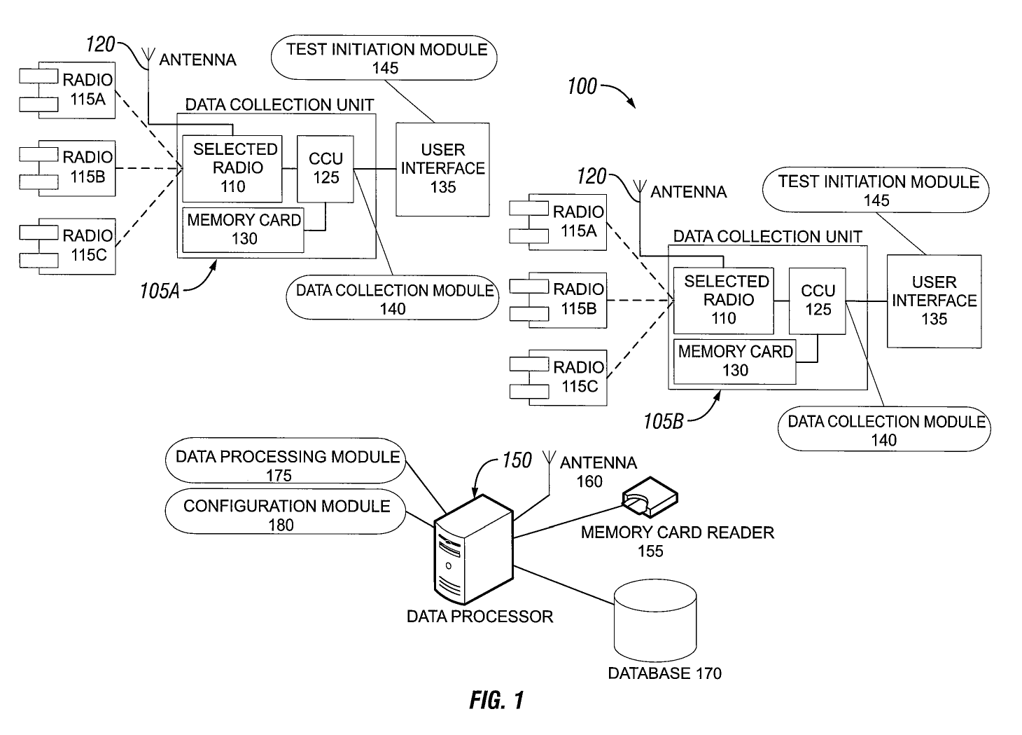

Referring to FIG. 1, an exemplary system 100 for system for determining path loss in a use environment may include at least two test devices or data collection units 105A, 105B and a data processor 150. While not necessarily physically interconnected, the data collection units 105A, 105B and data processor 150 form a system 100 as a result of their interoperability and data sharing. Moreover, the data collection units 105A, 105B may be designed as portable or mobile devices to facilitate the data collection process. Each data collection unit 105A, 105B may include a radio 110 selected from a plurality of available radios 115A, 115B, 115C configured to establish a radio link and communicate via an antenna 120. Although three available radios are shown, any number maybe present. The selected radio 110 may be controlled by a central control unit (CCU) 125. The CCU may have an interface to a storage medium such as a memory card 130. A user interface 135 provides access to the commands and controls of the CCU 125. A data collection module 140 may provide software instructions for controlling the CCU 125. Similarly, a test initiation module 145 may provide test controls via the user interface 135.

Each data collection unit 105A, 105B may include the same physical elements but may be configured differently via software instructions. As will be discussed in detailed below, data collection units 105A, 105B may be configured to be a master or slave device during the data collection process. In general, the master device is responsible for initiating a link test and for collecting the full data set of sent data and received data. The slave device generally responds to the master device by echoing back the received data. The slave device collects only the received data to account for the possibility that the return data to the master does not arrive.

The available radios 115A, 115B, 115C may include various radio frequency communication technologies. For example, a radio may be provided for wireless communication technologies such as zwave, zigbee, wireless USB, blue tooth, WI-FL, etc. Each radio 115A, 115B, 115C generally defines a communications protocol as well as the frequency and power settings associated therewith. In generally, radios 115A, 115B, 115C using certain technologies may not be able to communicate with other radios 115A, 115B, 115C of a different type of technology. Accordingly, the selected radio 110 of each of the data collection units 105A, 105B may need to correspond with each other. While a data collection unit 105A, 105B with only one available radio technology may be feasible, providing multiple radio technologies may add to the versatility of the unit. For example, the data collection units 105A, 105B may be used to select the optimal radio technology 115A, 115B, 115C for a particular use environment. However, if its is known that only a single radio technology will be used for every use environment, the selected radio 110 may be permanently established as one of the available radio technologies 115A, 115B, 115C.

In one exemplary approach, the available radios 115A, 115B, 115C may be provided as physically distinct hardware components. For example, radio manufactures may make so-called development kits available to facilitate and simplify the testing of a particular technology. The development kit may provide the radio on a circuit board with standard interface connections, such as a bus connection for connecting to the CCU 125 and an antenna connection for connecting to the antenna 120. In such an approach, the selection of the radios 115A, 115B, 115C may include the physical association thereof with the data collection unit 105A, 105B. However, in another exemplary approach, the selected radio 110 may include a single set of radio circuitry which may be configured with software to communicate according to one of the available radios 115A, 115B, 115C. For example, the switch from communicating between WI-FL and zigbee may be controlled via software rather than by swapping physical components.

The antenna 120 may be an external antenna connected to the selected radio 110. An external antenna 120 may facilitate the data collection process. For example, the antenna may be provided on a mast that can be maneuvered by an operator. Such movement may allow for the collection of data in continuously varied positions throughout the use environment. However, in other exemplary approaches, the antenna may be provided within an outer casing of the data collection unit 105A, 105B, or even within the circuitry of the selected radio 110. The antenna may be paired with the particular radio 115A, 115B, 115C used as the selected radio 110. For example, a radio that operates in the 900 MHz range of frequency and a radio that operates in the 2.4 GHz range of frequencies may respectively need antennas 120 capable of receiving and transmitting radio communications in the 900 MHz and 2.4 GHz ranges.

The CCU 125 may be any generalized processing component capable of interfacing with the selected radio 110, the memory card 130, and the user interface 135. In one exemplary approach, the CCU 125 may provide a general purpose or embedded computer system with physical interface ports for the other elements of the data collection unit 105A, 105B. The CCU 125 may include program memory for storing computer instructions, such as the instructions of the data collection module 140. The program memory may be capable of receiving instructions from another source one time or multiple times. For example, the memory may be erasable or flashable in order to receive new instructions. In one exemplary approach, the program memory may be distinct from the memory card 130.

The memory card 130 generally includes a relatively large capacity data storage medium. Moreover, the storage medium may be removable such that any data stored thereon may be provided to a different device. So-called flash memory cards provide flash memory based storage mediums according to various physical form factors and interfaces, SD, Micro SD, Compact Flash, XD Memory, etc. Rather than a memory card 130, other storage mediums such as disk drives may be provided for data storage. Moreover, the disk drive may be configured to be removable or be permanently fixed. If permanently fixed, the CCU 125 may need an interface for transferring the collected data or may need instructions for operating the selected radio 110 and antenna 120 to wirelessly transfer the collected data.

The user interface 135 presents controls to a human operator of the data collection unit. In one exemplary approach, the user interface 135 includes a screen or monitor in order to present a graphical user interface (GUI) or similar depiction of the available controls. The user interface 135 may be integrated with the other components of the data collection unit 105A, 105B, or may be provided by a distinct device. In one exemplary approach, the user interface 135 may be provided by a handheld computer, or the like, linked to the CCU 125. For example a handheld computer may be connected to a serial interface of the CCU 125. Using an external device, such as a handheld computer, as the user interface 135 may simplify the CCU 125. For example, the CCU 125 would only need to provide software instructions for responding to control signals and data provided by the user interface 135.

While the functions of the data collection and test initiation modules 140, 145 will be discussed in detail below, the modules generally include software instructions for controlling the operation of the data collection units 105A, 105B. For example, the data collection module 140 may operate the selected radio 110 to communicate with other data collection units 105A, 105B, store and retrieve data from the memory card 130, and receive commands from the user interface 135. The test initiation module provides instructions for presenting and operating the user interface 135. Because the user interface 135 may be a distinct hardware element, the test initiation module 145 is depicted as being associated therewith. However, in another exemplary approach in which the user interface 135 is integrated with the data collection unit 135, the test initiation module may provide instructions for controlling the CCU 125.

The data processor 150 may analyze the data after it is collected by the data collection units 105A, 105B. The collected data may be received by the data process 150 by a memory card reader 155 or through a wireless network antenna 160. The data may be stored in a database 170 to facilitate its analysis. A data processing module 175 may provide instructions for organizing and filtering the collected data, for converting the indications of link quality to path loss values, for generating probability distributions using the collected data, for comparing the expected link quality of a plurality of radios 115A, 115B, 115C, and for recommending a particular radio 115A, 115B, 115C for a given use environment. The configuration module 180 may provide a graphical user interface for entering data necessary for configuring the data collection units 105A, 105B.

The data processor 150 represents general processing capabilities that may be provided by a general purpose computer server or personal compute (PC), as well as by a specialized embedded system. Moreover, the data processor 150 may be any computer system capable of operating the instructions provided by the data processing and configuration modules 175, 180. While depicted as distinct elements, the role of the data processor 150 may be filled by one of the data collection units 105A, 105B in another exemplary approach. For example, given a sufficient degree of processing power and enough storage space, the instructions of the data processing and configuration modules 175, 180 could be configured to operate on either the CCU 125 or the user interface 135. The data processor may have software, such as an operating system with low-level driver software, and the like, for communicating with peripheral devices and communication interfaces such as the memory card reader 155 and the antenna 160.

Database 170 may be a relational database management system (RDBMS). Many such systems, including SQL Server, Oracle, and MySQL, among others, are generally available. Database 170 generally stores the collected data in row and column table format, and may include multiple tables. A row, or record, includes one or more columns, or fields, holding data values for specifically defined fields. Rows may be uniquely identified by the values of one or more columns. Indexes of one or more columns can be included to aide in searching for particular rows of the table.

CCU 125, user interface 135, and data processor 150 may employ any of a number of user-level and embedded operating systems known to those skilled in the art, including, but by no means limited to, known versions and/or varieties of the Microsoft Windows® operating system, the Unix operating system (e.g., the Solaris® operating system distributed by Sun Microsystems of Menlo Park, Calif.), the AIX UNIX operating system distributed by International Business Machines of Armonk, N.Y., and the Linux operating system. Computing devices may include any one of a number of computing devices known to those skilled in the art, including, without limitation, a computer workstation, a desktop, notebook, laptop, or handheld computer, or some other computing device known to those skilled in the art.

CCU 125, user interface 135, and data processor 150 may each include instructions executable by one or more processing elements such as those listed above. Computer-executable instructions may be compiled or interpreted from computer programs created using a variety of programming languages and/or technologies known to those skilled in the art, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of known computer-readable media.

A computer-readable medium includes any medium that participates in providing data (e.g., instructions), which may be read by a computer. Such a medium may take many forms, including, but not limited to, non-volatile media, and volatile media. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

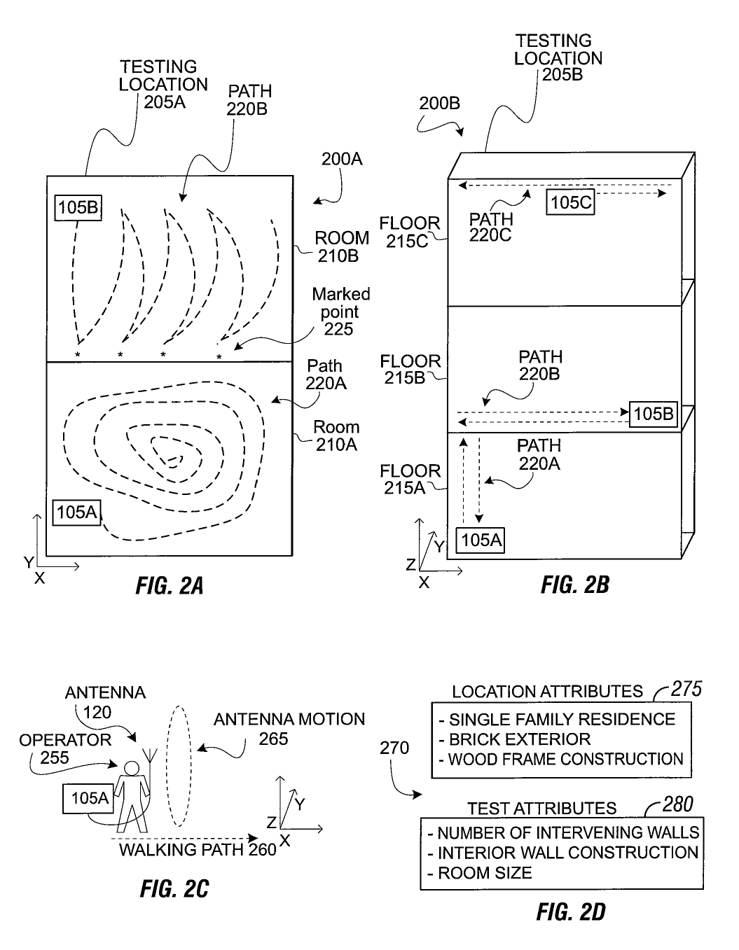

Referring to FIGS. 2A and 2B, the disclosed system 100 may be operated in different use environments 200A, 200B such as testing locations 205A, 205B. A testing location 205A, 205B is generally a physical structure such as a residential home, apartment, office building, etc. The testing location may be physically divided into multiple rooms 210A, 210B. The rooms 210A, 210B may be separated with walls or other barriers that could potentially result in signal interference and path loss. As will be explained in more detail below, a link test may be defined as the link quality, or expected link quality, between two rooms of a testing location for a selected radio technology 110. Rather than focusing on the link quality and path loss between two fixed points in the testing location 205A, 205B, the system may generate an expected link quality that is generalized for any point within the room 210A, 210B subjected to testing. The mobile nature of the data collection units 105A, 105B may allow for data collection throughout any points of the two rooms 210A, 210B. The data collection units 105A, 105B may be configured to continuously sample the quality of the radio link while being transported throughout the rooms 210A, 210B.

The data collection units 105A, 105B may be transported along respective paths 220A, 220B. Each path 220A, 220B may be designed to cover as many positions in the room 210A, 210B as possible. However, in an alternative approach, the path 220A, 220B may only traverse areas that are likely deployment locations for a wireless node. For example, it may be known that nodes will only be positioned along a wall. Thus the path 220A, 220B may simply follow the walls of the room 210A, 210B. As explained above, the data collection units 105A, 105B may be configured to continuously record indications of the link quality all along the path 220A, 220B.

Even with the continuously recorded indications of link quality, there may be some points of the room 210A, 210B that have particular significance. For instance, a certain point might have a large amount of interference, or might represent an ideal location for an installed node. Accordingly, some points along the path 220B may be indicated as marked points 225. The user interface 135 may include a control for indicating that a point should be marked. The marking simply flags the next indication of link quality. Any indications of link quality associated with a marked point may be filtered out by the data processor 150. Depending on the selected configuration, the data processor 150 may only use the indications of link quality associated with a marked point, may exclude the data associated with marked points, or may apply a weighting factor to the data. Alternatively, a number corresponding to a predetermined location or specific location information, such as global positioning system (GPS) data, may be provided.

An aspect of the system 100 relates to the timing of the data collection while the data collection units 105A, 105B are in motion. However, because the indication of link quality may be affected by the distance between the data collection units 105A, 105B, the relative positions thereof may need to be varied during the data collection process in order to achieve a useful sampling of the entire room 210A, 210B. As illustrated, the collection units 105A, 105B may be moved all paths 220A, 220B having different patterns. However, in another exemplary approach, the data collection units 105A, 105C may be moved at different rates of speed. To assist the operators with moving the data collection units at different rates of speed, the user interface 135 may emit an audible or visual pacing signal. Alternatively, the user interface may provide pathway guidance or instructions.

As illustrated in FIG. 2B, link tests may be conducted between different floors 215A, 215B, 215C of a multi-floor testing location 205B with different paths 220A, 220B, 220C associated with different data collection units 105A, 105B, 105C. FIG. 2B further illustrates that the path 220A of a data collection unit 105A could include vertical movement. However, it is to be understood that despite not being depicted in three dimensions, the paths in testing location 205A of FIG. 2A could also included vertical movements. Additionally, FIG. 2B includes more than two data collection units 105A, 105B, 105C. Even when using more than two data collection units 105A, 105B, 105C, a link test will typically be conducted between only two units, e.g., 105A and 105C. As will be discussed below, the third unit 105B, may be used, if necessary, as a bridge between the units 105A and 105C involved in the actual link test.

Some radio based communication technologies 115 may implement so-called mesh networking. Mesh networking is known for allowing any communicating node to route communications to any other node within its vicinity. Each communication has an identified recipient such that the communication may hop from one node to the next until it reaches its intended recipient. If the selected radio 110 is capable of mesh networking, the test initiation module may present a mesh networking selection option in the user interface 135. Whether or not mesh networking is enabled may also be a test attribute that is stored in association with the data. Additionally, the data may record the number of hops required to reach the destination node. By recording the number of hops, the collected data can later be filtered and analyzed to determine if the addition of a mesh node would improve link quality between two end point nodes.

Referring to FIG. 2C, a human operator 255 may participate in the data collection process. While FIG. 2C only depicts one operator 255, typically a testing location 205 will have more than one operator, or at least two data collection units regardless of whether the units are attended to by an operator. For example, while carrying the data collection unit 105A and an attached antenna 120, the operator 255 may traverse a walking path 260. As discussed above, the path may follow the layout of the room being tested. Additionally, the operator may vary his walking pace to further vary the position of the data collection unit 105A with respect to the other data collection unit 105B. In addition to walking, the position of antenna 120 may be varied by the operator 255 to provide additional antenna motion 265. For example, the operator 255 could swing the antenna in a circular pattern while walking.

As noted above, indications of link quality, such as path loss, can vary greatly with only a minor change in node placement. Accordingly, moving the antenna during testing may allow for the collection of many data points thereby accounting for any peaks and valleys in the link quality. Any motion 265 may be sufficient. However, motion that positions the antenna in likely installation positions may provide ideal results. For example, if it is known that the antenna will never be more than four feet off the floor and no more than four feet from a wall, the antenna motion 265 may follow any pattern within these constraints. It is to be understood that there is no particular need for a human operator 255. For example, an automated or robotic device capable of negotiating the testing location 205 may be used to carry the data collection unit 105A and antenna 120.

Referring to FIG. 2D, tables 270 list location attributes 275 and test attributes 280 that may be established in the database 170 by the configuration module 180. The location attributes 275 may be established for every defined test in a particular location. The attributes may detail structural information about the location 205. For example, the test attributes 280 may be established for each set of areas being tested within a given location. For example, if tests are conducted between two rooms of a location, the test attributes 280 may record the number of intervening walls between the rooms, the wall constructions, the general size of the room, etc. Both the location and test attributes 275, 280 may be used to tag the collected data. By tagging the data it may be used to simulate a different use environment with corresponding characteristics. For example, data collected in a single family residence with a brick exterior may be able to predict the link quality that would be expected in another use environment that is a single family residence with a brick exterior. As will be detailed below, the attributes 275, 280 may be established prior to conducting any data collection.

A number of methods may be preformed using the above described system 100. The methods may include preliminary configuration steps, data collection steps, and post collection processing steps. In combination, the methods may be able to determine an overall indication of link quality for the plurality of available radios 115. A comparison of the overall indications of link quality may be used to determine an optimal radio 115. The tagging of the collected data may allow for the prediction of link quality for a given radio 115 in a corresponding use environment.

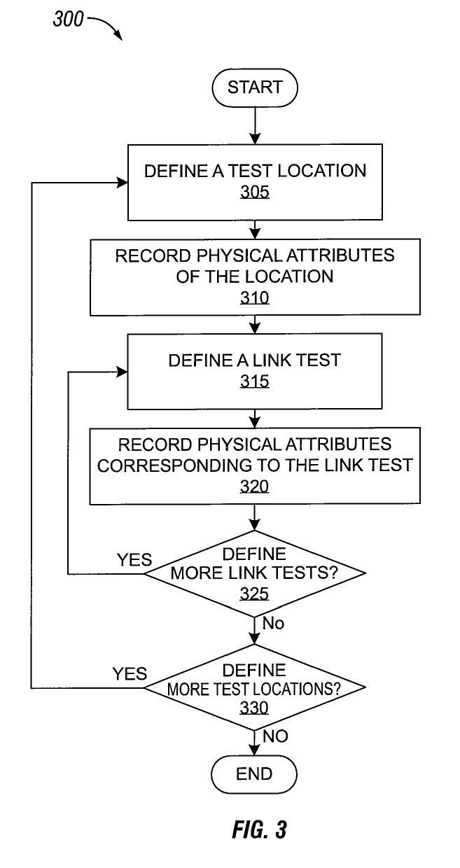

FIG. 3 is a flowchart depicting exemplary steps and decisions related to a configuration process 300. The data processor 150 may include a computer-readable medium having stored instructions for carrying out certain operations described herein, including some or all of the operations described with respect to process 300. For example, some or all of such instructions may be included in configuration module 180. Some steps of process 300 may include user input and interactions. However, it is to be understood that fully automated or other types of programmatic techniques may implement steps that include user input. In general, the configuration process 300 prepares the database 170 to receive data from a particular use environment and also may configure the data collection units with the link tests that are to be completed at a particular location. The configuration module 180 may provide a graphical user interface to the database 170 for entering the configuration data. While depicted as a module 180 of the data processor 150, the configuration process could be conducted on the user interface 135.

Process 300 begins in step 305 in which a test location, or use environment, may be defined 305. The test location may be a building or other structure where a wireless communication network will be installed. A unique identifier may differentiate multiple defined test locations. The unique identifier may be an address, the name of the operator running the test, or any other alphanumeric set or characters.

Next, in step 310, physical attributes 275 of the location may be recorded. As discussed above, the physical attributes 275 may identify a class of structure, as well as structural details such as the type of materials used in construction. For example, the physical attributes 275 may identify the location as an office building with steel frame construction and brick exterior walls.

Next, in step 315, one or more link tests for the location may be defined. A link test generally identifies the location of one data collection unit 105a to another 105b. For example, a location may have multiple rooms which may be identified by alphanumeric identifiers. Thus a link test may be defined, for example, for testing between a kitchen and a laundry room of a residential location.

Next, in step 320, physical attributes 280 corresponding to the link test may be recorded. As discussed above, the physical attributes 280 may include the number of intervening walls between the data collection units 105, the interior wall construction, the general size of the room, etc. These attributes 280 may be associated with any collected data in order to predict the results of another link test in a location with corresponding attributes.

Next, in step 325, it may be determined if more link tests need to be defined. For example, after storing the first link test and associated attributes, the user interface for the configuration process 300 may prompt the user to optionally create another link test. A location may have a plurality of rooms and the operator may wish to conduct tests between each combination of rooms. In general, the number of link tests increases exponentially with the number of locations to be tested. The number of link tests may be calculated according to the formula (number of testing locations)²—(number of testing locations). For example, six testing locations would require 30 link tests to be defined. If more link tests are to be defined, process 300 may return to step 315. If no more link tests need to be defined, process 300 may proceed to step 330.

In step 330, it may be determined if more test locations need to be defined. For example, an operator 255 may preload a plurality of the test locations at one time. An operator 255 may intend to conduct link quality surveys at a number of off site locations and may wish to predefine all of the locations to avoid the need to work on the data processor 150 in between tests. However, in another exemplary approach in which the configuration process 300 may be conducted on the user interface 135, predefining the locations may not be that important. If more tests locations are to be defined, process 300 may return to step 305. However, if there are no more tests to define, process 300 ends.

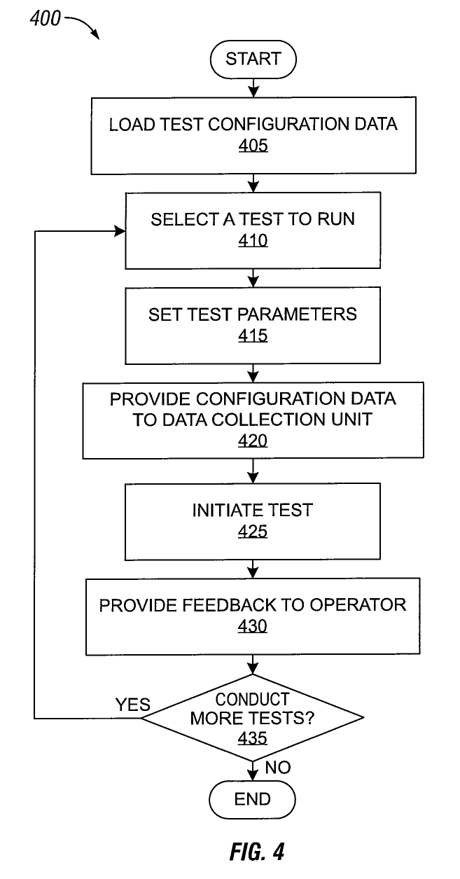

FIG. 4 is a flowchart depicting exemplary steps and decisions related to a data collection initiation process 400. The user interface 135 may include a computer-readable medium having stored instructions for carrying out certain operations described herein, including some or all of the operations described with respect to process 400. For example, some or all of such instructions may be included in the test initiation module 145. Some steps of process 400 may include user input and interactions. However, it is to be understood that fully automated or other types of programmatic techniques may implement steps that include user input.

Process 400 may begin in step 405 in which test configuration data may be loaded onto a data collection unit 105. In one exemplary approach, the handheld computer based user interface 135 may connect to the database 170 to retrieve the test configuration data defined in process 300. For example, the handheld computer based user interface 135 may provide a serial connection for interfacing and exchanging data with the database 170 and the CCU 125.

Next, in step 410, the user interface 135 may present the operator 255 with a list of defined locations for selection. The operator 255 may use the user interface to select an appropriate location from the provided choices. Subsequent to selecting a location, the operator 255 may be prompted to select a particular test that has been defined. For example, the operator may select a test defined for testing link quality between a bathroom and a laundry room of the selected location.

Next, in step 415, test parameters may be set. As discussed above, the data collection units may be configured as either a master or slave device. The master device generally initiates a test and collects the full set of link test data. The slave device responds to the master device and saves any data that it receives from the master. Further, in a test involving more than two data collection units 105, mesh networking may be enabled. For example, rather than requiring data collection units to establish links directly from one unit 105 to another 105, intervening units may be permitted to bridge or mesh the link. The test parameters may be associated with any collected data. Moreover, when meshing is enabled, the collected data may store an indication of the number of intervening units that were required to establish a link.

Next, in step 415, the configuration data may be provided to the data collection unit 105. For example, the handheld computer acting as the user interface 135 may maintain a serial connection to the CCU 125. Upon selection of a test, the configuration data may be transferred across the interface to the CCU 125. As will be discussed below, the CCU 125 may use the configuration data to tag the collected link quality data.

Next, in step 425, the operator 255 may initiate the selected test. The user interface 135 may provide a control that can be selected by the operator 255 to initiate the test.

Next, in step 430, the user interface 135 may provide feedback to the operator 255. For example, the user interface 135 may report on the on going data transfers between the data collection devices 105. There may be a count down timer, or the like, indicating the remaining time for the test. Additionally, the user interface 135 may provide visual or audible signals that the operator 255 can use to walk at an appropriate pace.

Next, in step 435, it may be determined if there are more tests to conduct. For example, the operator 255 may be prompted to select another test to complete. If there remaining tests to conduct, process 400 may return to step 410. However, if there are no remaining tests, process 400 may end.

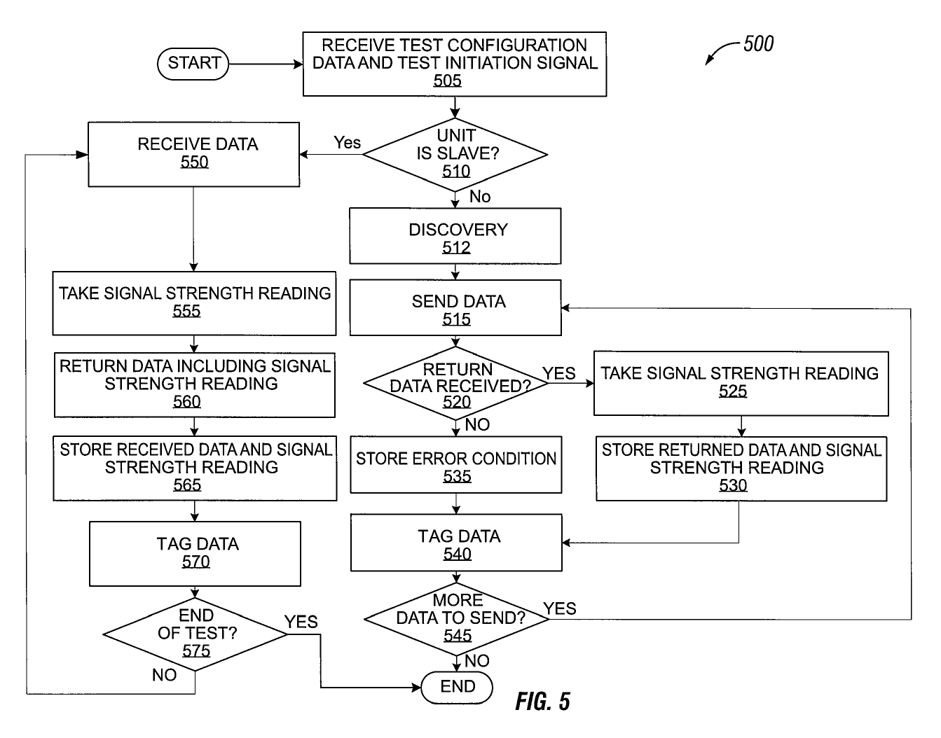

FIG. 5 is a flowchart depicting exemplary steps and decisions related to conducting a data collection between master and slave data collection units. The CCU 125 may include a computer-readable medium having stored instructions for carrying out certain operations described herein, including some or all of the operations described with respect to process 500. For example, some or all of such instructions may be included in the data collection module 140.

Process 500 begins in step 505 when the CCU of the data collection unit 105 receives the test configuration data and the initiation signal from the user interface as discussed above with respect to process 400.

Next, in step 510, it may be determined whether the data collection unit 105 is acting as a master or slave device. As explained above, the data collection unit 105 may include identical hardware and software regardless of whether it is a master or slave in the data collection process. The configuration data may provide an indication of whether the unit should operate as a mater or slave device. If the unit is a slave device, the process may skip to step 542. However, if the unit is a master device, the process may proceed to step 512.

In step 512, the master may undertake a discovery process. For example, the master unit may attempt to discover the presence of any other data collection units in test range and exchange node identification information and logical identification information. This information is used to create a routing table for packet delivery over the wireless communications network. This discovery process may continue for a set period of time before stopping, e.g., five seconds.

Next, in step 515, the data collection unit acting as a master may send data to the slave device. The data may contain information such as which unit it was sent by, and a time stamp corresponding to the sending time.

Next, in step 520, it may be determined whether return data has been received from the slave device. As will be discussed below, the slave device is configured to echo back the data sent by the master. Accordingly, the master unit may wait for a set period of time to receive the return data. If the set period of time expires without receiving return data, process 500 may skip to step 535. However, if return data is received, process 500 may proceed to step 525.

In step 525, a signal strength reading associated with the return data may be taken. For example, the selected radio 110 may report the RSSI value associated with the return data. Additionally, a timestamp corresponding to the time the return data was received may be recorded and associated with the return data. This time stamp along with an initial time stamp may be used to calculate a round-trip time. Calculating and recording the round-trip time may provide additional data for use in choosing a particular radio technology. For example, in addition to basing the choice of a radio technology on the probability of successful communication, the decision may also be based on a predicted average time to communicate between two points in a given environment.

Next, in step 530, the return data, RSSI, return data timestamp, and round-trip time may be stored. For example, the CCU 125 may store these values to the memory card 130. The data may be stored in a database table format, a flat file format, or according to any other data organization scheme.

If return data was not received in step 520, an error condition may be stored in step 535. The error condition may be associated with the sent data to indicate that data was never returned to the master device.

Next, in step 540, the data may be tagged. The configuration data received in step 505 may include attributes for tagging the data such as location attributes 275 and test attributes 280. Additionally, the data may be tagged with an indication or identifier of the radio technology being tested. The tagging of the data may allow for later filtering during data processing and analysis as discussed above with respect to process 600.

Next, in step 545 it may be determined whether there is more data to send. For example, a link test may be configured to run for a certain length of time, or may be configured to send a specified amount of data. Accordingly, if there is more data to send, process 500 may return to step 515. However, if there is no more data to send process 545 ends.

If the device is acting as a slave device as determined in step 510, the slave loop may first wait in step 550 to receive data sent by the master. The received data corresponds to the data sent may the master in step 515 as discussed above.

Next, in step 555, an RSSI reading may be taken upon receipt of the data. Additionally, a timestamp corresponding to the time the data was received may be recorded in association with the data.

Next, in step 560, the received data along with the RSSI reading and timestamp may be returned or echoed back to the master.

Next, in step 565, the received data along with the RSSI reading and timestamp may be recorded to the memory card 130 of the slave. The received data may be stored in the event that the return data does not arrive at the master. Accordingly, at least data from the master to the slave will be stored even if the return data is lost.

Next, in step 570, the stored data may be tagged. As discussed above in step 540, the stored data may be tagged with attributes that will later be used to filter the data.

Next, in step 575, it may be determined whether the test has concluded. As explained above, a test may run for a given period of time or a given amount of data. Also, there may an upper time limit to a test even if the test run is based on an amount of data. Accordingly, if the test has not ended, process 500 may return to step 550 to wait for more data. However, if all data has been received, or if the time limit of the test has been reached, process 500 ends.

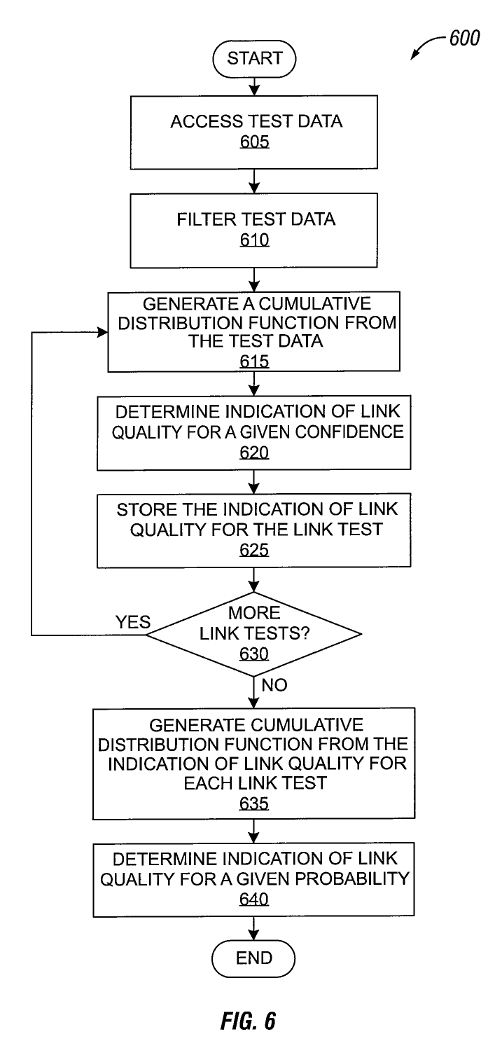

FIG. 6 is a flowchart depicting exemplary steps and decisions related to a process 600 for analyzing collected data samples. The data processor 150 may include a computer-readable medium having stored instructions for carrying out certain operations described herein, including some or all of the operations described with respect to process 600. For example, some or all of such instructions may be included in the data processing module 175. Some steps of process 600 may include user input and interactions. It is to be understood that fully automated or other types of programmatic techniques may implement steps that include user input.

Process 600 begins in step 605 in which the collected test data may be accessed. In one exemplary approach, the test data will have been loaded in the database 170 at a prior time. In such an approach, step 605 may only involve allowing the data processing module 175 access to the database 170, e.g., connecting or logging in to the database 170. In another exemplary approach, the data from the data collection units may need to be loaded into the database. The memory card may be removed from the data collection unit 105 and inserted into the card reader 165. A script or other function may be provided in the data processing module 175 to read the data from the memory card and insert the data into the database 170.

Next in step 610, the test data may be filtered. The database 170 may include test data from a plurality of link tests for a plurality of testing locations. Generally, data may be filtered to include only test data from tests that share some corresponding test attributes 180. Filtered data will not be deleted from the database 170, but may be excluded from the remaining steps. Data may be filtered according to any of the location attributes 275 or any of the test attributes 280. After filtering, the data set will include a plurality of link quality indication values associated with one or more link tests.

Next in step 615, a cumulative distribution function may be generated from the data. The data associated with a single link test will be aggregated and used to generate a cumulative distribution function correlating the link quality with a probability or placement confidence. In general, the generation of the distribution function will be accomplished via a mathematics software library.

Next, in step 620, an indication of link quality may be determined for a given confidence level. Using the distribution function generated in step 615, a particular confidence level may be specified by the user. For example, the user may require an 80 percent confidence that the link quality will be at least as good as the value resulting from the distribution function.

Next, in step 625, the indication of link quality for the specified confidence level that was determined in step 620 may be stored for later use in step 635.

Next, in step 630, it may be determined if there are more link tests to analyze. For example, the filtering in step 610 may have resulted in data from a certain number of link tests to be included in the data set. If there are more link tests to analyze, the process may return to step 615. However, if there are no more link tests to analyze, the process may continue to step 635.

In step 635, another cumulative distribution function may be generated. Each of the overall indications of link quality for the particular link tests that were determined in step 620 may be aggregated and used to generate this additional cumulative distribution function. Accordingly, this cumulative distribution function will correlate the overall indications of link quality for the link tests with a confidence level, or a probability of successful communication.

Next, in step 640, the required link margin may be determined for a given probability. In generally, when installing a wireless communication network, one will want to know for a required success probability, what level of link margin is required. Accordingly, the user may specify the necessary success probability level, e.g., 95%, and determine the required link margin using the cumulative distribution function.

Following step 640, process 600 ends.

As described above, process 600 may use the collected data points to generate one or more cumulative distribution functions. However, other data analysis techniques may be equally effective. For example, multiple regression analysis may be used to identify correlations between independent and dependent variables of the data. In one exemplary approach, the average indication of link quality may be taken as a dependent variable while associated data such as the number of walls, the construction materials, etc., may be independent variables. The correlation may then be used to derive an equation for predicting the dependent variable based on the independent variables. Accordingly, multiple regression analysis may be used in place of the cumulative distribution functions above.

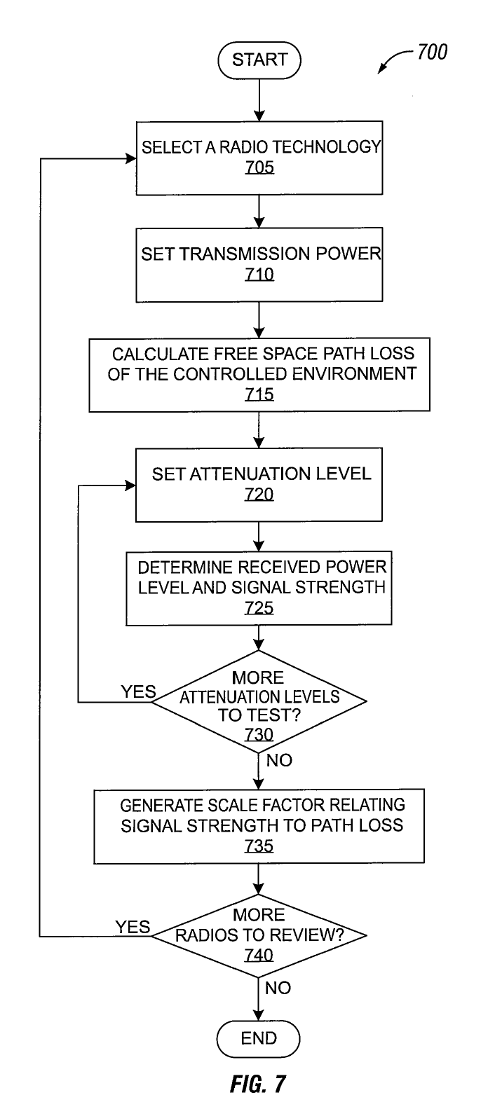

FIG. 7 is a flowchart depicting exemplary steps and decisions related to a process 700 for developing a scaling factor relating signal strength to path loss. Testing equipment and a processing computer may include a computer-readable medium having stored instructions for carrying out certain operations described herein, including some or all of the operations described with respect to process 700. Some steps of process 700 may include user input and interactions. However, it is to be understood that fully automated or other types of programmatic techniques may implement steps that include user input.

As discussed above, there may be a number of radio technologies that may be possible to use. However, different radio technologies may not be suitable for a particular use environment due to the different techniques for dealing with interference. Therefore, it may be desirable to compare different radio technologies against each other in order to determine the optimal technology for a given use environment. Radio technologies generally report an indication of link quality as a so-called received signal strength indication (RSSI). However, RSSI values do not provide a suitable means for comparing one radio to another because there is no standardized way to calculate RSSI values. Even different manufactures of the same radio technology may report different RSSI values under the same use conditions. Accordingly, the reported RSSI values may need to be converted or normalized into a form suitable for comparison with other radio techniques.

Path loss, a measure of signal power degradation may provide a normalized value suitable for comparing different radio technologies. However, a scaling factor may need to be developed to accurately convert RSSI to a path loss value.

Process 700 begins in step 705 in which a radio technology may be selected for analysis. In one exemplary approach, each radio technology will be provided by distinct physical hardware. Accordingly, selecting a radio is simply a matter of choosing the appropriate physical component that provides the desired radio technology. However, if a physical device combines the circuitry and protocol implementation for various radio technologies, the desired technology may need to be enabled.

Next, in step 710, the transmission power may be set to a base line level. To calculate path loss, the transmission power must be set to a base line or known level. This level may be used as described below in step 715.

Next, in step 715, the free space path loss may be calculated for the test environment and the base line power level. Process 700 may be performed in a controlled testing environment. For example, such an environment may be isolated from interference and noise. However, at a minimum, any interference and noise will need to be consistent across all iterations. In this controlled environment, the free space or expected path loss may be calculated using the transmission power level.

Next, in step 720, an attenuation level may be set. A configurable power attenuator may be used to alter the transmission power level to a new power level. The transmitting radio may be operated at the attenuation level.

Next, in step 725, the received signal strength indication may be determined at a receiving radio. Additionally, the reported RSSI may be recorded. The attenuation level, the received signal strength, and the reported RSSI value may be recorded for later use. The received power level may be used with an expected power level for the given attenuation level may be used to calculate a path loss value.

Next, in step 730, it may be determined if there are more attenuation levels to test. For example, in order to create an accurate scaling factor, numerous attenuation levels may need to be tested. If there are remaining attenuation levels, process 700 may return to step 720. However, if there are no more attenuation levels to test, the process may proceed to step 735.

In step 735, a scale factor relating RSSI to path loss may be generated. In one exemplary approach, the reported RSSI and path loss values may be related using a look-up table or the like. Accordingly, there may only be path loss values for certain RSSI values. However, in another exemplary approach, the reported RSSI and path loss values it may be possible to fit the relationship between RSSI and path loss to a specific factor or functional relationship.

Next, in step 740, it may be determined if there are more radios to review. If there are more radios to review, process 700 may return to step 705. However, if there are no more remaining radios to review, process 700 ends.

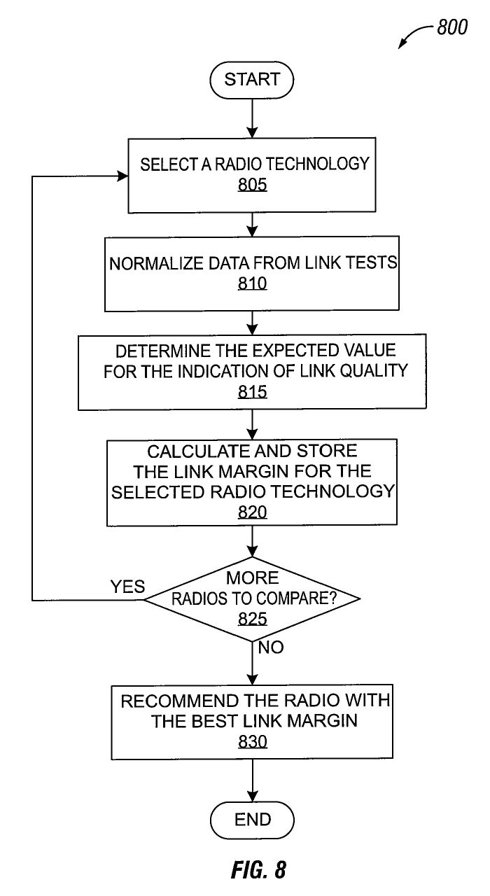

FIG. 8 is a flowchart depicting exemplary steps and decisions related to a process 800 for recommending a radio technology for a particular use environment. The data processor 150 may include a computer-readable medium having stored instructions for carrying out certain operations described herein, including some or all of the operations described with respect to process 800. For example, some or all of such instructions may be included in the data processing module 175. Some steps of process 800 may include user input and interactions. However, it is to be understood that fully automated or other types of programmatic techniques may implement steps that include user input.

Process 800 beings in step 805 in which a radio technology may be selected for comparison. Link tests may be associated with a particular radio technology. Accordingly, data from numerous link tests may be filtered to only include the data associated with the desired technology.

Next, in step 810, the link quality indication values in the remaining data set may be normalized into a comparable form. For example, the scaling factor developed in process 700 for the selected radio technology may be used to convert RSSI values to path loss values.

Next, in step 815, using the link quality indication values that have been converted to path loss values, an expected indication of link quality (i.e. path loss) may be determined. Process 600 address the determination of an expected indication of link quality. However, the generic description of link quality indication values will in fact be the normalized path loss values calculated in step 810.

Next, in step 820, the link margin for the selected radio technology may be calculated based on the expected path loss determined in step 815. Radio frequency communication technologies may have a minimum power level for communication between nodes. Link margin may be the level of received signal power above this minimal level. Accordingly, the expected path loss may be used to calculate an expected received power level. The link margin may be calculated by reducing the expected received power level by the minimum power level. The link margin may be stored for later use.

Next, in step 825, it may be determined if there are more radios to compare. If there are remaining radios to compare, process 800 may return to step 805. However, if there are no more radios to compare, process 800 may proceed to step 825.

In step 825 a recommendation may be made based on the calculated link margins. For example, the radio technology with the best link margin may be recommended. Following step 825, process 800 ends.

This description should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

Various modifications from the system and method described above and various permutations and combinations of the features described are contemplated. For example, the data collection unit may receive and transmit a signal to the data processor with or without any processing and with or without storing any information. Link testing may be conducted in furnished or unfurnished rooms, in rooms with programmed or random mobile signal barriers, such as people walking around, and rooms with programmed or random sources of electromagnetic interference, such as appliances and consumer electronic devices operating.

More particularly, the use environment may include passive sources of interference such as walls and other aspects of the structural components of the building. However, the use environment may additionally include noise and interference caused by sources other than simply the structural components of the building. For example, there may be electrical appliances, physical obstructions, etc. Moreover, these additional sources of interference may be statically positioned or dynamically positioned. For example, a use environment may include a metallic obstruction statically posited in a fixed location. However, in another example use environment such as a commercial laundry, there may be many sources of electrical interference caused by the random operation of machines as well as interference from people moving throughout the laundry facility.

To account for additional sources of interference, the data collection process may be conducted in the use environment that contains the corresponding sources of expected interference. For example, if it is known that an electrical appliance will typically be functioning in a particular location of the use environment, a corresponding source of interference may be provided during the data collection process. The source of interference may be a controlled known source, such as another data collection unit programmed to provide a predetermined type of interference. However, in the case of dynamic, or random, sources of interference, it may be impossible to provide corresponding sources during the data collection. Accordingly, dynamic sources of interference may be simulated during the data collection process in order to provide an approximation of the expected link quality. Alternatively, the actual expected sources of interference may be introduced into the environment and measurements taken over time in a staged or random use of these sources of interference.

Moreover, the mobile nature of the data collection units may produce data samples throughout the use environment such that some areas may be affected by the dynamic changes while others are not. The generation of the probability distribution function using the data sample may aggregate and account for these variances. Additionally, these sources of interference may be identified in the test configuration data such that the data samples may be tagged and later filtered based on the interference that may occur.

Therefore various methods, components and systems have been described which may be used for the installation of a network, identifying signal quality, determining the probability of communications, and/or selecting network design parameters. Of course, it is to be understood that the present invention has various aspects, embodiments, alternatives, and versions.

For example in one version, a system includes at least one portable radio frequency data transmitter; at least one portable radio frequency data receiver; and a data processing device configured to analyze a plurality of indications of link quality collected during communication between the transmitter and receiver, wherein the position of the transmitter and receiver relative to each other varies during the communication.

In another version, a system includes at least one radio frequency data transmitter; at least one radio frequency data receiver; and a data processing device configured to calculate a probability of successful communication between the transmitter and receiver based on the analysis of a plurality of link quality indication values collected during communication between the transmitter and receiver, wherein the relative positions of the transmitter and receiver are altered during the communication.

In still another version, a system includes a plurality of radio frequency based data communication units for generating a plurality of link quality indication values including at least a first unit configured to transmit radio frequency based data communications and a second unit configured to receive the data transmitted by the first unit, wherein the first and second unit are selectively configured to communicate using one of a plurality of radio frequency technologies during at least one link test; and a data processing device. The data processing device is configured to receive the plurality of link quality indication values resulting from communications between the transmitter and receiver and collected thereby during the link test; normalize at least a subset of the values for comparison across the plurality of radio frequency technologies; and compare an overall indication of link quality across the plurality of radio frequency technologies.

In one variation of any of the foregoing versions, the data processing device is further configured to calculate a probability of successful communication between the transmitter and receiver. In a further variation, the movement of the transmitter is confined within a bounded first location and the movement of the receiver is confined within a bounded second location and the probability of successful communication provides a generalized probabilistic value for communication between any point of the first location to any point of the second location. In a still further variation, the movement of the transmitter and receiver are restricted to the locations within the respective first and second locations where a transmitter and receiver are most likely expected to be located. In a yet further variation, at least one of the transmitter and receiver are restricted to a perimeter region of a room.

In other variations, the position of the transmitter and receiver relative to each other varies during the communication by moving the transmitter and the receiver at different speeds or along different paths. In still another variation, specific locations of at least one of the receiver and the transmitter are marked, such as by a flag, a number or specific location data.

In another variation, the data processing device is further configured to receive indications of link quality from the transmitter and receiver using a plurality of radio frequency communication technologies, and to recommend an optimal radio frequency communication technologies based on a comparison of the indications link quality for the plurality of technologies.

In still another variation, the plurality of indications of link quality are tagged with at least one testing attribute. The attribute may, for example, be information about the use environment, such as location of the transmitter or receiver, or information about the test, such as the type of radio frequency technology being used. In a further variation, the data processing device is further configured to predict an expected indication of link quality for an untested location having attributes corresponding to the at least one testing attribute.

In another variation, the indication of link quality is represented as path loss.

In still another variation, at least one radio frequency data repeater is configured to communicate with the transmitter and the receiver, wherein the data processing device is configured to analyze a plurality of indications of link quality collected during communication between the transmitter and receiver through the repeater, wherein the position of the transmitter and receiver relative to each other varies during the communication. In a further variation, the position of repeater varies relative to the at least one of the transmitter and the receiver during the communication, for example, by moving the repeater, the transmitter and the receiver at different speeds.

In another variation, at least one radio frequency interference generator is configured to generate electromagnetic interference during the communication. In a further variation, the interference generator varies during the communication by at least one of varying in frequency, varying in intensity, and moving relative to the transmitter and the receiver.

In yet another variation, at least one movable radio frequency barrier is provided capable of moving during the communication.

In other variations, each of the transmitter and receivers comprises a radio, and antenna and a user interface, each of the transmitter and receivers are transceivers configurable alternatively as a receiver or transmitter, each of the transmitter and receivers is selectively configurable as a master or a slave, each of the receiver and transmitter are capable of selectively using at least two alternative radio frequency communication technologies, and/or each of the receiver and transmitter may use at least one of zwave, zigbee, wireless USB, blue tooth, and WI-FL.

In still another variation, the data collection unit is incorporated into at least one of the transmitter and the receiver.

In yet another variation, at least one of the transmitter and receiver is configured as a master and the other of the transmitter and receiver is configured as a slave, the master being capable of initiating a link test and gathering data and the slave responding to the master by echoing received data. In a further variation, the slave collects received data to account for return data not received by the master.

Various methods provide for analyzing an environment for the installation of a network, identifying signal quality, determining the probability of communications, and selecting network design parameters. The present invention contemplates numerous options, alternatives, embodiments, variations, and versions of such methods.

In one version, a method includes collecting a plurality of indications of link quality during communications between a receiving and an transmitting portable radio frequency communication devices; altering the position of the receiving and transmitting devices relative to each other during the collecting; and analyzing the plurality of indications of link quality to determine an overall indication of the link quality.

In still another version, a method includes collecting a plurality of indications of link quality during communications between at least one radio frequency data transmitter and at least one radio frequency data receiver; and analyzing the plurality of indications of link quality to determine an overall indication of the link quality.

In yet another version, a method includes collecting a plurality of indications of link quality during communications between a plurality of radio frequency based data communication units; analyzing the plurality of indications of link quality to determine an overall indication of the link quality, normalizing at least a subset of the values for comparison across the plurality of radio frequency technologies; and comparing the overall indication of the link quality across the plurality of radio frequency technologies.

In still yet another version, a method includes accessing a data set of link quality indication values generated from at least one link test, wherein the link test includes a plurality of radio frequency based communications between at least two data collection units; generating a cumulative distribution function using the data set; and calculating a particular link quality indication value for a given placement confidence probability value using the cumulative distribution function.

In still yet another version, a method includes performing at least one link test between at least two radio frequency communication devices and calculating a probability of successful communication between the communication devices for each respective link test based on the path loss data for the respective link test. The at least one link test may include establishing one of a plurality of radio frequency technologies as a subject technology for the link test; setting collection characteristics for the link test; initiating a plurality of data communications between the devices; altering the physical locations of the devices relative to each other throughout the link test; collecting path loss data throughout the link test; and tagging the path loss data with at least one of the collection characteristics and an identifier of the subject technology.

In variations of any of these methods, the method may further include moving the transmitter and the receiver at different speeds during the communications, moving the transmitter and the receiver along different travel patterns during the communication, converting the link quality indication values into path loss values prior to generating the cumulative distribution function, calculating a probability of successful communication as the overall indication of link quality, representing the indication of link quality as path loss, tagging the indications of link quality with at least one testing attribute, predicting an expected indication of link quality for an untested location having attributes corresponding to the at least one testing attribute, determining an expected link margin for each of a plurality of radio frequency communication technologies based on the expect link quality calculated with link quality indication values collected for each of the radio frequency communication technologies, collecting at least one testing attribute including at least one of an identifier of the radio frequency technology implemented by the data collection units and at least one characteristic of the collection environment, and/or recommending an optimal radio frequency communication technology.

In still another variation, the method further includes communicating between the receiving and transmitting devices using a plurality of radio frequency communication technologies; comparing the overall indication of link quality for each radio frequency communication technology; and recommending an optimal technology based on at least the comparing.

In another variation, the movement of the transmitter is confined within a bounded first location and the movement of the receiver is confined within a bounded second location and wherein the probability of successful communication provides a generalized probabilistic value for communication between any point of the first location to any point of the second location.

In yet another variation, at least one of the receiver and the transmitter is moved in a three dimensional path during the communication, for example, by moving at least one of the receiver and the transmitter along a generally horizontal pathway while simultaneously oscillating it vertically to define a three dimensional path.

In yet another variation, at least some of the plurality of indications of link quality collected during communication involve communication between the transmitter and receiver through a repeater. In further variations, the position of the repeater varies relative to the transmitter and the receiver during the communication, for example, by moving the repeater, the transmitter and the receiver at different speeds, along different travel patterns, or at a plurality of fixed repeater location options.

In still another variation, at least some of the plurality of indications of link quality collected during communication involve a known source of electromagnetic interference between the transmitter and receiver during the communication. In further variations, the interference varies during the communication by at least one of varying in frequency, varying in intensity, and originating in a source moving relative to the transmitter and the receiver.

In still yet another variation, at least some of the plurality of indications of link quality collected during communication involve a radio frequency barrier between the transmitter and receiver during the communication. In further variations, the barrier may move or change during the communication.

In another variation, the method further includes aggregating the particular link quality indication value a for a plurality of link tests having corresponding testing attributes; assembling a second cumulative distribution function from the aggregated link quality indication values; and calculating an expected link quality indication value for a given probability of success value using the second cumulative distribution function.

In still yet another variation, the method includes moving the transmitter and receiver to the locations where a transmitter and receiver are most likely expected to be located, such as along the perimeter of a room or along the walkways within a room.

In another variation, the method includes aggregating indications of link quality for a plurality of link tests having corresponding testing attributes; assembling a cumulative distribution function from the aggregated link quality indication values; and calculating an expected link quality indication value for a given probability of success value using the second cumulative distribution function.

In yet another variation, the method includes normalizing at least a subset of the values for comparison across the plurality of radio frequency technologies; and comparing the overall indication of the link quality across the plurality of radio frequency technologies. In a further variation, the method includes determining an expected link margin for each of a plurality of radio frequency communication technologies based on the expect link quality calculated with link quality indication values collected for each of the radio frequency communication technologies.

It is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

What is claimed is:

1. A method for selecting a wireless communication system for use in a home appliance based on path loss within a use environment, the method comprising:
providing a first data collection unit and a second data collection unit, each of the first data collection unit and the second data collection unit comprising a wireless transceiver and adapted for wireless communication therebetween;
physically moving the first data collection unit to each of a plurality of different locations within the use environment associated with use of the home appliance;
establishing a radio frequency link between the first data collection unit and the second data collection unit at each of the plurality of different locations within the use environment; and
characterizing quality of the radio frequency link at each of the plurality of different locations, the quality of the radio frequency link being at least partially based on the path loss within the use environment;
determining an aggregate characterization of the first data collection unit within the use environment using the quality of the radio frequency link at each of the plurality of different locations.

2. The method of claim 1 wherein the aggregate characterization is a probability that the first data collection unit provides an adequate radio frequency link within the use environment.

3. The method of claim 1 wherein the use environment is a room within a home environment.

4. The method of claim 3 wherein the physically moving the first data collection unit to each of the plurality of different locations comprises physically moving the first data collection unit along a predetermined path within the room.

5. The method of claim 1 further comprising recording physical attributes associated with each of the plurality of locations.

6. The method of claim 1 further comprising selecting a first configuration for the wireless transceiver of the first data collection unit and the wireless transceiver of the second data collection unit for the radio frequency link.

7. The method of claim 6 wherein the first configuration comprises a radio technology type and a transmission power.

8. The method of claim 6 further comprising selecting a second configuration for the wireless transceiver of the first data collection unit and the wireless transceiver of the second data collection unit and using the second configuration in establishing the radio frequency link between the first data collection unit and the second data collection unit at each of the plurality of different locations within the use environment.

9. The method of claim 1 wherein the step of characterizing quality of the radio frequency link at each of the plurality of different locations comprises determining signal strength of the radio frequency link at each of the plurality of different locations.

10. The method of claim 1 wherein the aggregate characterization comprises a cumulative distribution function derived from the quality of the radio frequency link at each of the plurality of different locations.

11. The method of claim 1 further comprising using the aggregate characterization of the first data collection unit within the environment to determine suitability of the wireless transceiver of the first data collection unit for use in the home appliance.

12. The method of claim 11 further comprising providing the home appliance, the home appliance comprising a wireless transceiver having a same type as in the first data collection unit.

13. A system for characterizing radio communications quality associated with a use environment, the system comprising:
a first data collection unit and a second data collection unit, each of the first data collection unit and the second data collection unit comprising a wireless transceiver and adapted for radio communication therebetween when at least one of the first data collection unit and the second data collection unit is within the use environment;
the first data collection unit and the second data collection further adapted for collecting radio link quality data for radio links made between the first data collection unit and the second data collection unit; and
a computing device in operative communication with at least one of the first data collection unit and the second data collection unit, the computing device having a data processing module stored on a computer readable medium, the data processing module adapted for processing the radio link quality data to provide an aggregate characterization of radio communications within the use environment.

14. The system of claim 13 wherein the aggregate characterization is a probability that the first data collection unit provides an adequate radio frequency link within the use environment.

15. The system of claim 13 wherein the use environment is a room within a home environment.

16. The system of claim 13 wherein the wireless transceiver of the first data collection device is a selected radio from a plurality of radios of the first data collection device.

17. The system of claim 13 wherein the radio link quality data comprises signal strength of the radio frequency link between the first data collection unit and the second data collection unit at a plurality of different locations within the use environment.

18. The system of claim 17 wherein the aggregate characterization comprises a cumulative distribution function derived from the quality of the radio frequency link at each of the plurality of different locations.

19. The system of claim 13 further a user interface associated with the computing device for displaying the aggregate characterization.

20. The system of claim 13 wherein the computing device is in operative communication with at least one of the first data collection unit and the second data collection via transfer of data from removable storage medium.
